(19) United States
(12) Patent Application Publication
(10) Pub. No.: US 2023/0142288 A1
(43) Pub. Date: May 11, 2023

(54) INFORMATION PROCESSING DEVICE, INFORMATION PROCESSING METHOD, AND RECORDING MEDIUM

(71) Applicant: NEC Corporation, Minato-ku, Tokyo (JP)

(72) Inventors: Kei SHIBUYA, Tokyo (JP); Kan ARAI, Tokyo (JP); Azusa FURUKAWA, Tokyo (JP); Makiko AKIGUCHI, Tokyo (JP); Hiroshi HASHIMOTO, Tokyo (JP); Ken HANNAZAWA, Tokyo (JP)

(73) Assignee: NEC Corporation, Minato-ku, Tokyo (JP)

(21) Appl. No.: 17/913,233

(22) PCT Filed: Mar. 30, 2020
(86) PCT No.: PCT/JP2020/014503

§ 371 Date: Sep. 21, 2022

(51) Int. Cl. G06Q 30/0601; G06Q 30/0251

(52) U.S. Cl. CPC G06Q 30/0631; G06Q 30/0261; G06Q 30/0269

(57) ABSTRACT

In an information processing device, a category setting unit sets a plurality of categories to a product, the category being a division representing characteristics of the product. A recommended product specifying unit specifies the product to be recommended to a customer as a recommended product. A display category specifying unit specifies a display category to be displayed as an advertisement, based on a condition including a customer attribute, from among the plurality of categories set to the recommended product. A display control unit displays a category display screen for displaying the display category on a display device.

### TECHNICAL FIELD

The present invention relates to a technique for specifying information on products to be provided to customers.

### BACKGROUND ART

Recently, the concept of decentralization of micro stores, which are miniaturized stores, has risen. However, when the number of stores increases due to the decentralization, the cost of shelf stocking also increases. Therefore, it is necessary to reduce stocks as much as possible and to suppress the cost of shelf stocking. For example, Patent Document 1 discloses managing the stocks of products displayed in the store, and displaying information such as a menu using the stocked products on a display installed in the store.

### PRECEDING TECHNICAL REFERENCES

### Patent Document

Patent Document 1: Japanese Patent Application Laid-Open under No 2005-250616

### SUMMARY

### Problem to be Solved by the Invention

Patent Document 1 is intended to present information on a menu using the stocked products or a finished product using the stocked products as parts. Also, Patent Document 1 does not assume stock management between multiple stores.

It is one object of the present invention to provide a method of specifying and displaying information that is effective for letting users buy products.

### Means for Solving the Problem

According to an example aspect of the present invention, there is provided an information processing device comprising:

a category setting unit configured to set a plurality of categories to a product, the category being a division representing characteristics of the product;

a recommended product specifying unit configured to specify the product to be recommended to customers as a recommended product;

a display category specifying unit configured to specify a display category to be displayed as an advertisement, based on a condition including a customer attribute, from among the plurality of categories set to the recommended product; and

a display control unit configured to display a category display screen for displaying the display category on a display device.

According to another example aspect of the present invention, there is provided an information processing method comprising:

setting a plurality of categories to a product, the category being a division representing characteristics of the product;

specifying the product to be recommended to customers as a recommended product;

specifying a display category to be displayed as an advertisement, based on a condition including a customer attribute, from among the plurality of categories set to the recommended product; and

displaying a category display screen for displaying the display category on a display device.

According to another example aspect of the present invention, there is provided a recording medium recording a program to cause a computer to execute processing comprising:

setting a plurality of categories to a product, the category being a division representing characteristics of the product;

specifying the product to be recommended to customers as a recommended product;

specifying a display category to be displayed as an advertisement, based on a condition including a customer attribute, from among the plurality of categories set to the recommended product; and

displaying a category display screen for displaying the display category on a display device.

### Effect of the Invention

According to the present invention, it is possible to specify and display information that is effective for letting users buy products.

### BRIEF DESCRIPTION OF THE DRAWINGS

FIG. 1 shows a schematic configuration of a category display system according to a first example embodiment.

FIG. 2 is a block diagram showing a hardware configuration of the information processing device.

FIG. 3 shows an example of a data structure of a category database.

FIG. 4 shows an example of a data structure of a product information database.

FIG. 5 shows an example of a data structure of a stock information database.

FIG. 6 shows an example of a data structure of a customer attribute information database.

FIG. 7 shows an example of a data structure of a historical information database.

FIG. 8 is a block diagram showing a functional configuration of the information processing device.

FIG. 9 shows an example of output of a category specifying model.

FIG. 10 is an example of a flowchart of category display processing.

FIG. 11 shows a schematic configuration of a category display system according to a second example embodiment.

FIG. 12 shows a functional configuration of an information processing device according to a third example embodiment.

### EXAMPLE EMBODIMENTS

Preferred example embodiments of the present invention will be described with reference to the accompanying drawings.

### First Example Embodiment

[Overall Configuration]

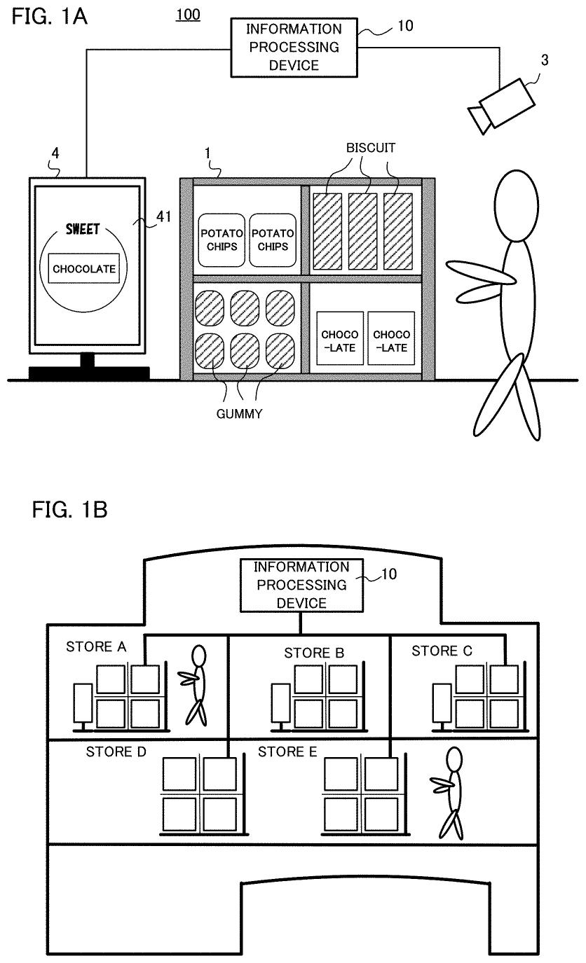

FIG. 1A shows a schematic configuration of a category display system according to the first example embodiment. The category display system 100 is installed in a small store or the like and displays categories to advertise products displayed on the product display shelf 1. The category display system 100 includes a camera 3, a signage 4, and an information processing device 10. The camera 3 and the signage 4 communicate with the information processing device 10 in a wired or wireless manner.

The camera 3 is provided to capture the face of the customer and a state in which the customer takes out the product from the product display shelf 1 or returns the product to the product display shelf 1. The camera 3 transmits, to the information processing device 10, an image or a video showing the state in which the customer takes out the product from the product display shelf 1 or returns the product to the product display shelf 1.

The signage 4 is a digital signage, which is a medium for displaying information and advertisements using electronic display devices such as displays instead of conventional paper posters and signboards. It is possible to combine digitized contents and switch display contents in units of seconds, and it can be utilized in every place such as in a store, outdoors, and in an office. The category display system 100 displays advertisements of the products wanted to be sold (also referred to as “recommended products”) on the signage 4 to advertise those products, when the customer comes to the store. Specifically, the signage 4 receives the category display screen from the information processing device 10 and displays it as an advertisement on the display unit 41 such as a display. As displayed on the display unit 41 of FIG. 1A, the category display screen displays the recommended product “Chocolate” and the category “Sweet” representing the characteristic of the product as described later in detail.

While the signage 4 is applied as a display device for displaying a category display screen in the present example embodiment, the present invention is not limited to this example. A smartphone, projection mapping by AR (Augmented Reality), or the like may be used if it can communicate with the information processing device 10.

FIG. 1B shows a schematic configuration of the category display system 100 installed in an office. For the category display system 100, the product display shelf 1, the camera 3, and the signage 4 are installed for each of the small stores existing in the office, and the information processing device 10 grasps the stock information and the customer attribute information of all the stores in real time by the camera 3 installed in each store. Incidentally, it is assumed that the information obtained by the camera 3, i.e., the image or video taken by the camera 3, includes the store identification information for identifying the store where the camera 3 is installed.

Specifically, in the present example embodiment, several types of products, about 5 to 15, are displayed on the product display shelf 1 depending on the size of the products, and each store has one product display shelf 1. Distances between the stores are relatively short, and when the product that the customer wants is out of stock at the store A, the customer can buy the product by going to the store B or store D, for example. Each store is unmanned, and the customers pay the price of the product by putting the money in a savings box. Staffs regularly visit each store to collect money and places or replenishes the products. Since a single staff has to replenish the products at multiple stores in one office, reducing the products left unsold per replenishment leads to a reduction of the replenishment cost. In other words, reducing the stocks of multiple stores in the office at the same time leads to the reduction the replenishment cost.

Incidentally, the category display system 100 of the present invention can be applied not only to the office, but also to a large shopping mall or in an outdoor facility in which multiple stores are arranged within a predetermined range. Hereinafter, the facility where the category display system 100 is set is also referred to as an “installation area”.

[Hardware Configuration of Information Processing Device]

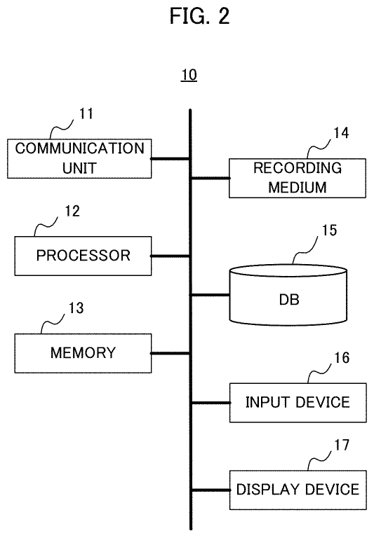

FIG. 2 is a block diagram showing a hardware configuration of the information processing device 10. As shown, the information processing device 10 includes a communication unit 11, a processor 12, a memory 13, a recording medium 14, a database (DB) 15, an input unit 16, and a display unit 17.

The communication unit 11 communicates with the camera 3 and the signage 4 in a wired or wireless manner. The processor 12 is a computer such as a CPU (Central Processing Unit) and controls the entire information processing device 10 by executing a program prepared in advance. Specifically, the processor 12 executes the category display processing described later. The communication unit 11 is an example of a transmission unit.

The memory 13 is configured by a ROM (Read Only Memory), RAM (Random Access Memory), or the like. The memory 13 is also used as a work memory during the execution of various processes by the processor 12.

The recording medium 14 is a non-volatile, non-transitory recording medium such as a disk-shaped recording medium, a semiconductor memory, and is configured to be detachable from the information processing device 10. The recording medium 14 records various programs executed by the processor 12. When the information processing device 10 executes various kinds of processing, a program recorded on the recording medium 14 is loaded into the memory 13 and executed by the processor 12.

The database 15 includes a category DB 21, a product information DB 22, a stock information DB 23, a customer attribute information DB 24, and a history information DB 25. The database 15 also stores video transmitted from the camera 3, images of each product, various information generated in the category display processing, and the like. The input unit 16 is a keyboard, a mouse, or the like for the user to perform instructions and inputs. The display unit 17 is a liquid crystal display or the like, and displays a predetermined screen or the like in accordance with the operation of the user.

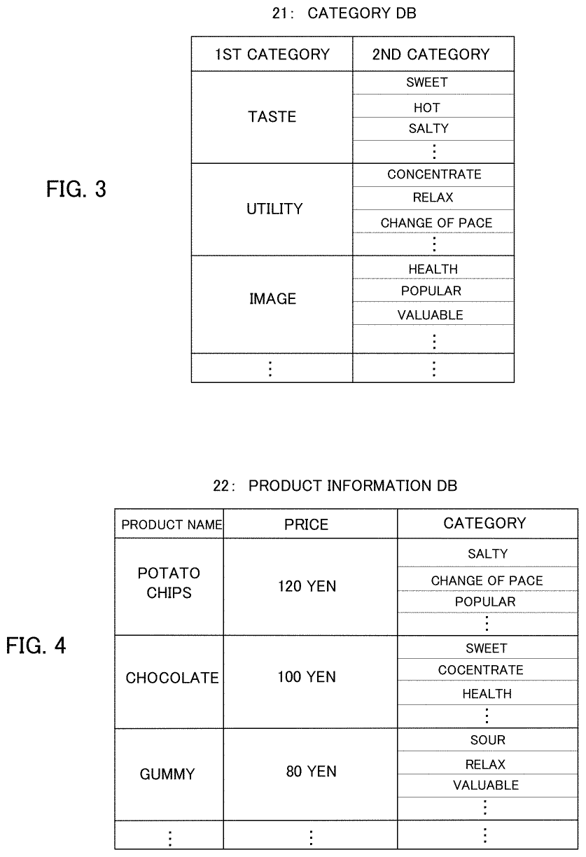

Here, the category DB 21, the product information DB 22, the stock information DB 23, the customer attribute information DB 24, and the history information DB 25 included in the database 15 will be described in detail. FIG. 3 illustrates an example of a data structure of the category DB 21. The category DB 21 is a database relating to the category and includes a first category and a second category. “Category” is a division set for products to be sold in stores, and represents characteristics such as feature or image of the products. The second category is the subdivision of the first category. Specifically, if the first category is “Taste”, the second category is the expression representing taste such as “Sweet”, “Spicy”, “Salty”, “Sour”. In the present example embodiment, the first category and the second category are tagged in advance to each product, and the “category” in the various databases is mainly the second category.

FIG. 4 shows an example of a data structure of a product information DB 22. The product information DB 22 is a database relating to the products to be sold in stores, and includes product names, prices, and categories. The product name is the name of the product, and the price is the selling price of the product. The category is the second category tagged to the product. Specifically, the product name “Potato chips” has a price of “120 yen” and is tagged with the categories such as “Salty” representing taste, “Change of pace” representing utility, and “Popular” representing an image. Thus, a plurality of categories can be arbitrarily tagged to a single product.

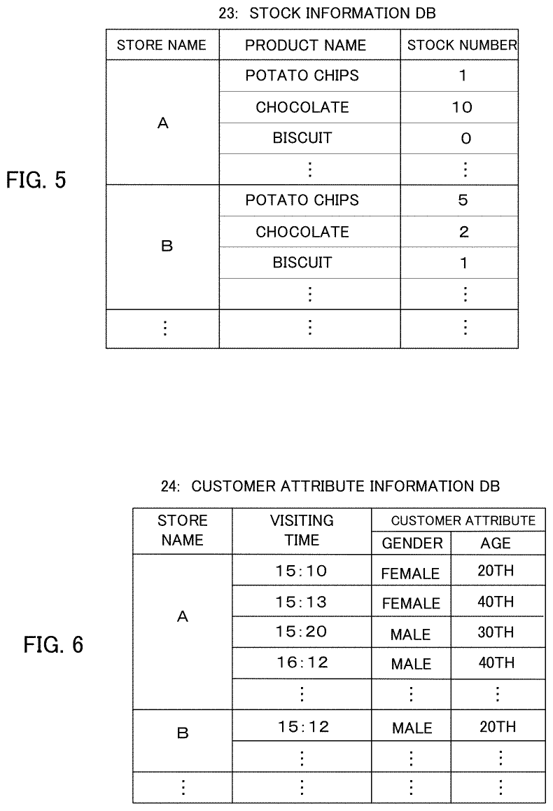

FIG. 5 shows an example of a data structure of the stock information DB 23. The stock information DB 23 is a database relating to the stocks of the products to be sold in each store, and includes store names, product names and stock numbers. The store name is the name of a small store installed in an installation area such as an office as shown in FIG. 1B. The product name is the name of the product to be sold in the store, and the stock number is the number of the products that remain in the store without being sold yet. Specifically, in the store A, the stock number is “1” for the product name “Potato chips”, the stock number is “10” for the product name “Chocolate”, and the stock number is “0” for the product name “Biscuit”. In other words, we can see that potato chips and biscuits are sold well and many chocolates remain unsold in the store A. In the store B, the stock number of “Potato chips” is “5,” the stock number of “Chocolate” is “2,” and the stock number of “Biscuit” is “1.” In other words, we can see that chocolates and biscuits are sold well and potato chips relatively remain unsold in the store B.

FIG. 6 illustrates an example of a data structure of the customer attribute information DB 24. The customer attribute information DB 24 is a database relating to the customer attributes and includes store names, visiting times, and customer attributes. The store name is the name of a small store installed in an installation area such as an office. The visiting time is the time at which the customer has visited the store. For example, the time of shooting the video including the face of the customer is acquired from the camera 3 as the visiting time in the store. The customer attributes are characteristics such as the nature and feature of the customer, e.g., gender and age. In the present example embodiment, the customer attribute is acquired by analyzing the video including the face of the customer captured by the camera 3, and the age is an approximate age.

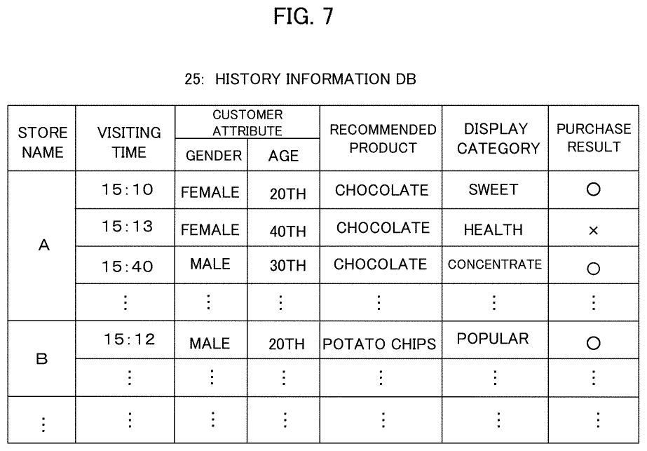

FIG. 7 shows an example of a data structure of a history information DB 25. The history information DB 25 is a database relating to the history of the information displayed by the signage 4 to the customer, and includes store names, visiting times, customer attributes, recommended product names, display categories, and purchase results. When a customer comes to the store, the category display system 100 displays an advertisement on the signage 4 containing the display category of a recommended product in order to advertise the recommended product. The recommended product name is the name of the recommended product displayed as an advertisement. The display category is the category that is displayed as an advertisement for the recommended product. The purchase result is information indicating whether or not the customer purchased the recommended product displayed as an advertisement. The purchase result is “0” when the recommended produced is purchased, and the purchase result is “x” when the recommended product is not purchased.

Specifically, by using the signage 4, the category display system 100 displayed “Chocolate”, which is a recommended product, as an advertisement together with the category “Sweet” to the customer of the twentieth female who visited the store A at 15:10. Also, the category display system 100 displayed “Chocolate”, which is a recommended product, with the category “Health” to the customer of fortieth female who visited the store A at 15:13. Further, the category display system 100 displayed “Chocolate”, which is a recommended product, with the category “Concentrate” to the customer of thirtieth male who visited the shop A at 15:40. Thus, the category display system 100 displays different categories as advertisements according to the attribute of the customer, even if the recommended products are the same. Although details will be described later, the category display system 100 uses a category specifying model to specify the most effective category that promotes customers' purchasing will from among multiple categories tagged to the products based on various conditions, and display the category as an advertisement.

[Functional Configuration of Information Processing Device]

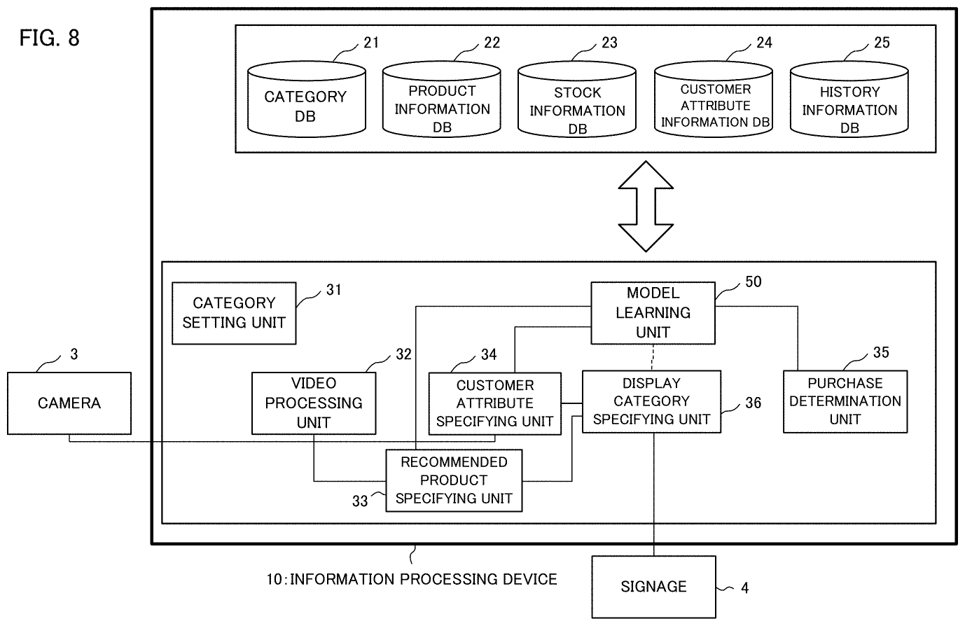

FIG. 8 is a block diagram showing a functional configuration of the information processing device 10. The information processing device 10 functionally includes a category setting unit 31, a video processing unit 32, a recommended product specifying unit 33, a customer attribute specifying unit 34, a purchase determination unit 35, a display category specifying unit 36, and a model learning unit 50. Each function transmits and receives information with the category DB 21, the product information DB 22, the stock information DB 23, the customer attribute information DB 24, and the history information DB 25 as needed.

The category setting unit 31 sets, to the product, a plurality of categories representing the characteristics of the product.

The video processing unit 32 acquires a video of the customer who has visited the store from the camera 3. Further, the video processing unit 32 acquires a video (hereinafter also referred to as an “in-and-out video”) that captures a state in which the products are taken out and put on the product display shelf 1 from the camera 3. The video processing unit 32 compares the in-and-out video acquired from the camera 3 with the images of the respective products stored in the database 15 to determine an increase or decrease in the present number of the products caused by taking-out and putting-in the products. When the video processing unit 32 determines that a certain product is taken out from the product display shelf 1 based on the in-and-out video, it reduces the stock number of the product stored in the stock information DB 23 by one. On the other hand, when the video processing unit 32 determines that the product display shelf 1 is replenished with a certain product based on the in-and-out video, it increases the present number of the product stored in the stock information DB 23 by one. Thus, the video processing unit 32 updates the stock number of the respective products stored in the stock information DB 23 based on the in-and-out video, each time the product is taken out from and put on the product display shelf 1. Therefore, the stock information DB 23 always store the stock numbers of the respective products at that time.

When the video processing unit 32 acquires the video of the customer who has come to the store, the recommended product specifying unit 33 refers to the stock information DB 23 and specifies the product whose stock number is largest at that time in the store that the customer visited as the recommended product. Although the product whose stock number is largest is specified as the recommended product in the present example embodiment, the present invention is not limited this example, and the recommended products may be arbitrarily set.

The customer attribute specifying unit 34 specifies the store name, the customer attribute, and the visiting time by analyzing the video of the customer who has visited the store acquired by the video processing unit 32, and updates the customer attribute information DB 24. The customer attribute specifying unit 34 is an example of a visiting time specifying unit.

The purchase determination unit 35 analyzes the video of the customer who visited the store, checks the stock numbers before and after the customer visited by referring to the stock information DB 23, and determines whether the customer purchased the recommended product. When the stock number did not change before and after the customer's visit, the purchase determination unit 35 determines that the customer did not purchase the recommended product. On the other hand, when the stock number is reduced after the customer's visit, the purchase determination unit 35 determines that the customer purchased the recommended product. The purchase determination unit 35 updates the history information DB 25 based on the determination result. Incidentally, instead of determining whether the product is purchased or not based on the stock number of the product, the purchase determination unit 35 may communicate with a POS (Point Of Sales) server (not shown) to acquire information as to whether the product is purchased or not.

The display category specifying unit 36 specifies the display category using the category specifying model based on the recommended product specified by the recommended product specifying unit 33 as well as the customer attribute and the visiting time specified by the customer attribute specifying unit 34, and then updates the history information DB 25. The category specifying model is learned and updated by the model learning unit 50. Further, the display category specifying unit 36 generates a category display screen for displaying the recommended product and the display category as an advertisement, and transmits the category display screen to the signage 4.

Here, the category specifying model will be described. The category specifying model is a model that is learned to receive the condition such as the visiting time to the store and the customer attribute as well as the recommended product at that time as the input data, and output the rank of the categories to be displayed together with the recommended product under the condition. The model learning unit 50 learns the category specifying model using the history information stored in the history information DB 25 illustrated in FIG. 7. Namely, when a customer of a certain customer attribute visited the store at a certain visiting time and a recommended product is displayed by a certain display category, the category specifying model is learned using the history information indicating whether or not the recommended product was purchased. Thus, the category specifying model is learned to output a rank of the display categories to be used for the recommended product when the visiting time, the customer attribute, and the recommended product are inputted. Then, the learned category specifying model is set in the display category specifying unit 36.

Further, every time a customer comes to the store, the model learning unit 50 learns and updates the category specifying model based on the purchase history information at that time. Thus, every time a customer comes to the store, the category specifying model is updated based on the purchase case at that time, and the category specifying model thus updated is set to the display category specifying unit 36. Therefore, the display category specifying unit 36 can always determine the display category using the latest category specifying model.

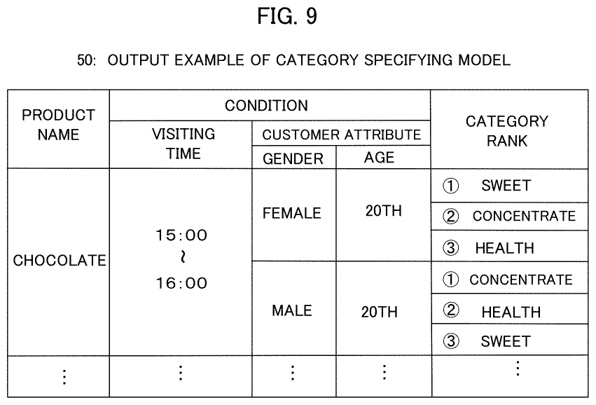

FIG. 9 is an output example of a category specifying model at a certain point of time. In this example, the category specifying model outputs “Sweet,” “Concentrate”, and “Health” as the rank of the display category at that time when a twentieth woman visits the store at the visiting time 15:00 to 16:00 and the recommended product at that time is Chocolate.

(Category Display Processing)

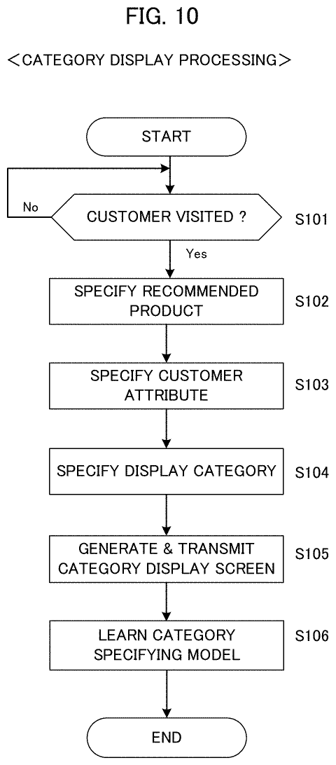

FIG. 10 is a flowchart of the category display processing. This processing is executed by the processor 12 shown in FIG. 2, which executes a program prepared in advance and operates as the elements shown in FIG. 8.

First, the video processing unit 32 determines whether or not the customer has visited the store from the video acquired from the camera 3 (step S101). If the customer has not visited the store (step S101; No), the video processing unit 32 waits until the customer visits the store. On the other hand, when the customer has visited the store (step S101; Yes), the recommended product specifying unit 33 refers to the stock information DB 23 and specifies, as the recommended product, the product whose stock number is largest in the store that the customer has visited (step S102). Further, the customer attribute specifying unit 34 specifies the customer attribute and the visiting time (step S103).

The display category specifying unit 36 specifies the category of the highest rank outputted by the category specifying model, as the display category, based on the recommended product as well as the customer attribute and the visiting time which are serving as the conditions (step S104). Then, the display category specifying unit 36 generates a category display screen for displaying the recommended product and the display category as an advertisement, and transmits it to the signage 4 (step S105). The signage 4 displays the category display screen received from the information processing device 10 on the display unit 41. Thus, as illustrated in FIG. 1A, the recommended product is displayed on the signage 4 together with the display category “Sweet”. Thereby, it becomes possible to promote the purchasing will of the customer.

Next, the model learning unit 50 learns the category specifying model based on whether or not the customer purchased the recommended product, and sets the category specifying model after the learning to the display category specifying unit 36 (step S106). Then, the processing ends.

As described above, the category display system 100 constantly grasps the products to be sold by checking the stock numbers of multiple stores in real time. In addition, the category display system 100 specifies the customer attributes of customers who visited the store in real time. Therefore, based on the stock numbers and the customer attributes, the category display system 100 can display appropriate recommended products to reduce the stock number as the advertisement together with an effective category that promotes customers' purchasing will. According to this, it is possible to adjust the products wanted to be sold out and to eliminate the stocks at multiple stores at the same time. Therefore, it is possible to reduce the remaining products at the time of replenishment, and it is possible to realize the reduction in the replenishment cost.

Further, in the category display system 100, the meaning of a single product is changed from various angles by setting a plurality of categories representing the characteristics of the product. This makes it possible to display an advertisement that is effective to let the customer select the hard-to-sell items, by the method other than varying information about the price of product, such as discounts. Furthermore, since the characteristics of the product can be presented to the customers by displaying the category as an advertisement, the burden of the customer in selecting the product can be reduced and the comfortable purchasing behavior can be realized.

[Modifications]

Next, modifications of the present example embodiment will be described. The following modifications can be applied in combination as appropriate.

(Modification 1)

In the present example embodiment, as the conditions used to specify the display category, the visiting time and the customer attributes are used. However, the present invention is not limited this example, and it is possible to use any conditions such as air temperature and weather when the customer visits the store.

(Modification 2)

In the present example embodiment, although the recommended product is specified based on the stock number in the store that the customer visited, the present invention is not limited this example. The recommended product may be specified based on the stock numbers in a plurality of stores. For example, if the stock numbers in the store A are generally small for all products and the stock number of potato chips in the store B is large, potato chips may be specified as the recommended product in the store A. In this case, when displaying an advertisement on the signage 4 of the store A, the information of the store B such as “Popular to some people! Restocked in store B!” may be displayed along with the recommended product and the display category. Since the category display system 100 constantly grasps products to be sold out in the multiple stores in the installation area by checking the stock numbers of multiple stores in real time, it is possible to identify the most effective recommended product as a whole of multiple stores, and it becomes possible to eliminate the stocks of multiple stores at once.

(Modification 3)

In the present example embodiment, the recommended product to be displayed as an advertisement in the signage 4 is one. However, the present invention is not limited this example, and a plurality of recommended products may be displayed as an advertisement. For example, if the store A has large stocks of chocolate and biscuit, those two products may be specified as the recommended products and displayed as an advertisement. Also, when the stock number of chocolate is large in the store A and the stock number of potato chips is large in the store B, those two products may be specified as the recommended products at both stores and displayed as advertisements together with information of other stores. When multiple recommended products are used, a category may be tagged to a combination of multiple products. In this case, the category specifying model outputs a rank of multiple categories tagged to the combination of the products. This allows the category display system 100 to display, as an advertisement, an effective category that promotes customers' purchasing will in accordance with the combination of multiple products.

(Modification 4)

In the present example embodiment, a plurality of categories are tagged in advance to the product, and the category display processing is performed without changing the category. However, the present invention is not limited this example. The category tagged to the product may be added, deleted, or changed based on the output of the category specifying model. This allows the category display system 100 to display more effective categories as advertisements.

(Modification 5)

In the present example embodiment, the payments for the products are placed in the savings box. However, the present invention is not limited this example, and a self-checkout machine or the like may be installed in the store. In this case, the category display system 100 has a POS server, and it is possible to manage the sales information and the stock information of the products through the network. In this respect, while the video processing unit 32 updates the stock numbers in the stock information DB 23 based on the in-and-out video in the present example embodiment, the stock numbers may be managed by the communication with the POS server instead. In that case, the camera 3 does not need to be capable of acquiring the in-and-out video, and it is sufficient that the camera 3 is capable of acquiring the video for obtaining the attribute of the customer in front of the product display shelf 1.

(Modification 6)

In the above-described example embodiment, the attribute information of the customer is acquired by the camera 3. However, an additional camera may be installed at a position to capture the video of the customer from his or her front side, and the attribute information of the customer may be acquired using the video captured by the additional camera.

### Second Example Embodiment

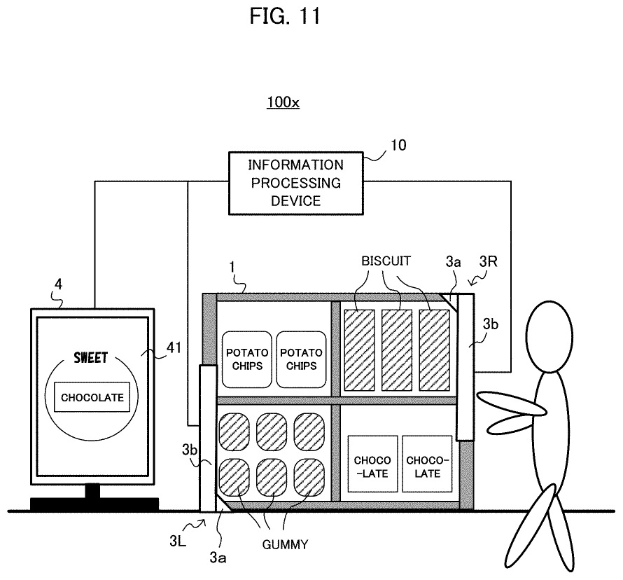

FIG. 11 shows a schematic configuration of a category display system according to the second example embodiment. The category display system 100x uses a pair of cameras 3R, 3L, instead of the camera 3 shown in FIG. 1A. Except for this point, the category display system 100x of the second example embodiment has the same configuration as the category display system 100 of the first example embodiment, and operates in the same manner.

The cameras 3R, 3L are provided to capture the face of the customer and a state in which the customer takes out and put on the products of the product display shelf 1, and transmits the video obtained by capturing a state in which the customer takes out the products from the shelf or returns the products to the shelf to the information processing device 10. In the second example embodiment, a pair of cameras 3R, 3L are attached to the frame of the product display shelf 1. Each of the cameras 3R, 3L includes a camera unit 3a and an illumination unit 3b. By the camera 3R mounted on the right side of the product display shelf 1, while the illumination unit 3b illuminates the front and front areas of the product display shelf 1, the camera unit 3a provided in the upper right corner of the product display shelf 1 captures the video of the entire front and front areas of the product display shelf 1 in the lower left direction. Similarly, by the camera 3L attached to the left side of the product display shelf 1, while the illumination unit 3b illuminates the front and front areas of the product display shelf 1, the camera unit 3a provided in the lower left corner of the product display shelf 1 captures the video of the entire front and front areas of the product display shelf 1 in the upper right direction. Since the left and right cameras 3R, 3L are used to capture the video of the hands of customer who takes out and returns the product from both the left and right sides, even if the product is hidden by the hand of customer who is holding the product in one of the videos captured from the left side and the right side, the product in the customer's hand is visible in the video captured from the other side.

### Third Example Embodiment

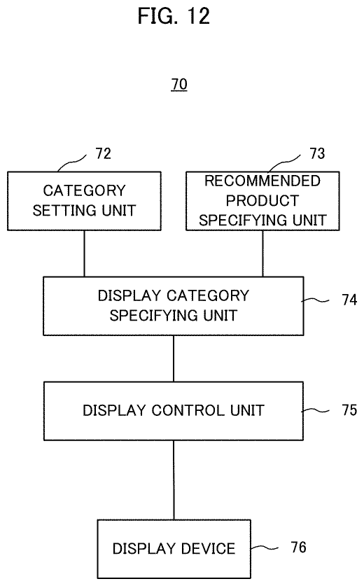

FIG. 12 shows the functional configuration of the information processing device according to the third example embodiment. As shown, the information processing device 70 includes a category setting unit 72, a recommended product specifying unit 73, a display category specifying unit 74, a display control unit 75, and a display device 76. The category setting unit 72 sets a plurality of categories to a product. The category is a division representing characteristics of the product. The recommended product specifying unit 73 specifies the product to be recommended to a customer as a recommended product. The display category specifying unit 74 specifies a display category to be displayed as an advertisement, based on a condition including a customer attribute, from among the plurality of categories set to the recommended product. The display control unit 75 displays a category display screen for displaying the display category on the display device 76.

A part or all of the example embodiments described above may also be described as the following supplementary notes, but not limited thereto.

(Supplementary Note 1)

An information processing device comprising:

a category setting unit configured to set a plurality of categories to a product, the category being a division representing characteristics of the product;

a recommended product specifying unit configured to specify the product to be recommended to customers as a recommended product;

a display category specifying unit configured to specify a display category to be displayed as an advertisement, based on a condition including a customer attribute, from among the plurality of categories set to the recommended product; and

a display control unit configured to display a category display screen for displaying the display category on a display device.

(Supplementary Note 2)

The information processing device according to Supplementary note 1,

wherein the products are sold in stores,

wherein the information processing device further comprises a visiting time specifying unit configured to specify a visiting time of the customer to the store, and

wherein the condition includes the visiting time.

(Supplementary Note 3)

The information processing device according to Supplementary note 1 or 2, further comprising:

a video processing unit configured to acquiring a video captured by a camera and including a face of the customer; and

a customer attribute specifying unit configured to specify the customer attribute from the video.

(Supplementary Note 4)

The information processing device according to Supplementary note 3, wherein the customer attribute is at least one of a gender and an age of the customer.

(Supplementary Note 5)

The information processing device according to any one of Supplementary notes 1 to 4, wherein the condition includes at least one of weather and air temperature.

(Supplementary Note 6)

The information processing device according to any one of Supplementary notes 1 to 5,

wherein the display category specifying unit specifies the category using a category specifying model generated by machine learning, and

wherein the category specifying model is learned to receive the condition and the recommended product as inputs and output the display category.

(Supplementary Note 7)

The information processing device according to any one of Supplementary notes 1 to 6, wherein the recommended product specifying unit specifies the product with a large number of stocks as the recommended product based on stock information related to the stocks of the product in a store.

(Supplementary Note 8)

The information processing device according to Supplementary note 7,

wherein the display device is installed in a plurality of stores, respectively, and

wherein the recommended product specifying unit specifies the recommended product based on the stock information in the plurality of stores.

(Supplementary Note 9)

The information processing device according to any one of Supplementary notes 1 to 8,

wherein the category setting unit sets a plurality of categories to a combination of two or more products, the category being a division representing characteristics of the combination of the products, and

wherein the recommended product specifying unit specifies the combination of the products as the recommended product.

(Supplementary Note 10)

An information processing method comprising:

setting a plurality of categories to a product, the category being a division representing characteristics of the product;

specifying the product to be recommended to customers as a recommended product;

specifying a display category to be displayed as an advertisement, based on a condition including a customer attribute, from among the plurality of categories set to the recommended product; and

displaying a category display screen for displaying the display category on a display device.

(Supplementary Note 11)

A recording medium recording a program to cause a computer to execute processing comprising:

setting a plurality of categories to a product, the category being a division representing characteristics of the product;

specifying the product to be recommended to customers as a recommended product;

specifying a display category to be displayed as an advertisement, based on a condition including a customer attribute, from among the plurality of categories set to the recommended product; and

displaying a category display screen for displaying the display category on a display device.

### DESCRIPTION OF SYMBOLS

1 Product display shelf
3, 3R and 3L Camera
4 Signage
10 Information processing device
31 Category setting unit
32 Video processing unit
33 Recommended product specifying unit
34 Customer attribute specifying unit
35 Purchase determination unit
36 Display category specifying unit
50 Model learning unit

What is claimed is:

1. An information processing device comprising:
a memory configured to store instructions; and
one or more processors configured to execute the instructions to:
set a plurality of categories to a product, the category being a division representing characteristics of the product;
specify the product to be recommended to customers as a recommended product;
specify a display category to be displayed as an advertisement, based on a condition including a customer attribute, from among the plurality of categories set to the recommended product; and
display a category display screen for displaying the display category on a display device.

2. The information processing device according to claim 1,
wherein the products are sold in stores,
wherein the one or more processors are further configured to specify a visiting time of the customer to the store, and
wherein the condition includes the visiting time.

3. The information processing device according to claim 1, wherein the one or more processors are further configured to:
acquire a video captured by a camera and including a face of the customer; and
specify the customer attribute from the video.

4. The information processing device according to claim 3, wherein the customer attribute is at least one of a gender and an age of the customer.

5. The information processing device according to claim 1, wherein the condition includes at least one of weather and air temperature.

6. The information processing device according to claim 1,
wherein the one or more processors specify the category using a category specifying model generated by machine learning, and
wherein the category specifying model is learned to receive the condition and the recommended product as inputs and output the display category.

7. The information processing device according to claim 1, wherein the one or more processors specify the product with a large number of stocks as the recommended product based on stock information related to the stocks of the product in a store.

8. The information processing device according to claim 7,
wherein the display device is installed in a plurality of stores, respectively, and
wherein the one or more processors specify the recommended product based on the stock information in the plurality of stores.

9. The information processing device according to claim 1,
wherein the one or more processors set a plurality of categories to a combination of two or more products, the category being a division representing characteristics of the combination of the products, and
wherein the one or more processors specify the combination of the products as the recommended product.

10. An information processing method comprising:
setting a plurality of categories to a product, the category being a division representing characteristics of the product;
specifying the product to be recommended to customers as a recommended product;
specifying a display category to be displayed as an advertisement, based on a condition including a customer attribute, from among the plurality of categories set to the recommended product; and
displaying a category display screen for displaying the display category on a display device.

11. A non-transitory computer-readable recording medium recording a program to cause a computer to execute processing comprising:
setting a plurality of categories to a product, the category being a division representing characteristics of the product;
specifying the product to be recommended to customers as a recommended product;
specifying a display category to be displayed as an advertisement, based on a condition including a customer attribute, from among the plurality of categories set to the recommended product; and
displaying a category display screen for displaying the display category on a display device.
